(19) United States
(12) Patent Application Publication
(10) Pub. No.: US 2014/0129439 A1
(43) Pub. Date: May 8, 2014

(54) SYSTEM AND METHOD FOR PROVIDING BANKING SERVICES ASSOCIATED WITH MULTIPLE FINANCIAL INSTITUTIONS THROUGH SHARED OUTLETS

(71) Applicant: Daniel Suisa, Kapuk Maura (ID)

(72) Inventor: Daniel Suisa, Kapuk Maura (ID)

(21) Appl. No.: 14/129,928

(22) PCT Filed: Jun. 28, 2011
(86) PCT No.: PCT/ID2011/000003

§ 371 Date: Dec. 28, 2013

(51) Int. Cl. G06Q 20/10; G06Q 20/18

(52) U.S. Cl. CPC G06Q 20/108; G06Q 20/18
USPC 705/42

(57) ABSTRACT

A system and method for providing banking services associated with a plurality of financial institutions through a network of shared outlets branded with each participating financial institution, wherein each shared outlet comprising a plurality of shared self service terminals for providing the branded and proprietary services including the unique and specific services of each participating financial institution, wherein each shared self service terminal is adapted or adaptable to provide equal services for each participating financial institution. The invention offers each participating financial institution to expand its branded service delivery outlets to deliver its branded services including the routine and non-routine services at shared cost.

### FIELD OF THE INVENTION

The invention relates to a network of outlets comprising a plurality of self service terminals that can be shared by multiple financial institutions for delivering their services, or more specifically, the invention relates to a system and method for providing automated banking services through shared outlets comprising a plurality of shared self service terminals for delivering the branded and proprietary services of each participating financial institution.

### BACKGROUND OF THE INVENTION

It is well known today that for efficiency purposes, most financial institutions especially retail banks prefer to expand their service delivery channels through automated or electronic systems, which include self service terminal system (ATM, cash dispenser machine, cash deposit machine, kiosk or other self service terminals), EDC (electronic data capture) terminal system or POS (point of sale) terminal system, mobile device system and internet system, instead of expanding through traditional branch offices.

A number of financial institutions have started deploying their own electronic kiosks or outlets consisting of multiple self service terminals to deliver their branded and proprietary services and made available for sharing of at least some of these self service terminals to other financial institutions on limited services only, which are typically cash withdrawal, balance inquiry and fund transfer. The other services such as payment, cash deposit, passbook update, account statement printing and other unique and specific services remain exclusive for the customers of the deploying financial institutions.

Generally, only bigger financial institutions can afford to massively expand such an electronic outlets, leaving the smaller financial institutions far behind and this will eventually create unfair competitions.

It is also generally known that about 80% or the majority of financial transactions are retail transactions. The electronic outlets described above, which can provide multi services such as cash withdrawal, balance inquiry, fund transfer, payment, cash deposit, passbook update, account statement printing and other routine services, can actually cover the delivery of the majority or about 80% of the services, leaving the minority or about 20% of the services being served at the traditional branch offices.

Therefore, it would be useful to propose the present invention, which is a network of shared outlets representing multiple financial institutions, each outlet comprising multiple shared self service terminals, which can deliver the majority of the services including the unique and specific services of each participating financial institution in a more cost efficient way.

The present invention can help smaller financial institutions to grow and expand like bigger financial institutions.

The present invention can allow bigger financial institutions as well as smaller financial institutions to relocate their investment budget for expanding their service delivery infrastructures to focusing on their core businesses including the development and innovation of better and more competitive products and services.

### SUMMARY OF THE INVENTION

The present invention is a system and method for providing banking services associated with a plurality of financial institutions through a network of shared outlets comprising a plurality of shared self service terminals, wherein each self service terminal can be adapted or can be prepared to provide equal services for each participating financial institution.

Initially, each service protocol, which is a set of rule and specification including the user displays and dialogues for performing a particular services, associated with each type of services required by each participating financial institution is specified/prepared and stored in a database.

Next, a plurality of shared self service terminals are prepared or adapted to provide the required services according to the specified service protocols. These prepared shared self service terminals are then installed in the shared outlets for being ready to serve the participating financial institutions' customers.

Next, a service initiation device such as a card, a passbook, a mobile phone or any other device associated with an account is presented by a user to one of the shared self service terminals for initiating a services.

Next, upon accepting the service initiation device, an identification information carried by the service initiation device is obtained. The identification information typically includes an information associated with a financial institution and an information associated with an account of the user or the device holder. The financial institution identification information is then acquired from the obtained information.

Next, a service protocol is selected and retrieved from the database based on the financial institution identification information and the service type selected by the user. The service protocol is then activated and executed to guide the system to interact with the user, in a manner specific to the respected financial institution, to generate a services or a transaction request.

Next, having generated the transaction, a host server associated with the respected participating financial institution is selected based on the financial institution identification information. The transaction is then forwarded or routed to the selected host server.

And finally, the selected transaction or services is executed according to the selected service protocol effecting the account associated with the presented service initiation device.

The present invention offers each participating financial institution to provide its branded and proprietary services including the unique and specific services for its customers.

The services can include routine services and non-routine services.

The routine services can include at least balance inquiry services, cash withdrawal services, cash deposit services, fund transfer services, payment services, passbook update services, account statement printing services and other services which can be automated through a self service terminal.

The non-routine services can include at least passbook issuing services, card issuing services, account opening services, account closing services, loan originating services, information collection services, information renewal/updating services, information distribution services, personal communication services between a customer and a financial institution and other services which can be automated through a self service terminal.

An example of information updating services can be a renewal or an update of customer data or account data through a secure transaction network.

The availability of non-routine services through secure transaction networks combined with wide-spread cost efficient shared service delivery channels, which are not traditionally available, can motivate financial institutions to move away such services from the traditional branch offices.

The present invention is expected to help financial institutions, large and small institutions, to expand their “proprietary” and branded service delivery networks to deliver their services in the most cost efficient way.

### BRIEF DESCRIPTION OF THE DRAWINGS

FIG. 1 is a simplified diagram of an exemplary network of shared outlets according to the present invention.

FIG. 2 is a simplified block diagram of a system according to an exemplary embodiment of the present invention.

FIG. 3 is a flow chart describing a preferred method of the present invention.

FIG. 4 is a simplified block diagram of an exemplary shared outlet according to the present invention.

### DETAILED DESCRIPTION OF THE INVENTION

An outlet is a room or a space, which can accommodate at least one self service terminal, which can allow at least one person to perform transactions on the at least one self service terminals concurrently inside or within the outlet.

A shared outlet is an outlet shared by at least two financial institutions for providing their services through the at least one self service terminal. A shared outlet can additionally accommodate at least one person for providing the services associated with the participating financial institutions, which are not supported or provided by the at least one self service terminal.

A network of shared outlets is a group of at least two shared outlets. The size of each shared outlet in the network can be different depending on the requirement. The design and layout of each shared outlet can also be different.

A self service terminal is an automated machine self-operated by a user for performing at least one transaction or services, the transaction can be a financial transaction or a non financial transaction or other type of transactions or services.

A self service terminal can be an automated cash dispenser or commonly regarded as an ATM (automated teller machine), an SSPP (self service passbook printer) or automated passbook update machine, an SSSP (self service statement printer) or automated statement printing machine, a CDM (cash deposit machine) or self service cash deposit machine, a CRM (cash recycling machine) or self service cash recycling machine, a self service information terminal, a kiosk, or any terminal self-operated by a user.

A shared self service terminal is a self service terminal which is prepared and made available for sharing among at least two institutions for providing their services.

The scope of services available at a shared self service terminal is traditionally limited, for example at a traditional shared ATM, the services available to the issuing financial institution is only limited to balance inquiry, cash withdrawal and fund transfer, while the complete services including payment and the unique and specific services only available to the acquiring (deploying) financial institution.

For other type of terminals, for example, SSPP and CDM, traditionally, the services are exclusive for the deploying financial institutions only and are not being shared with other financial institutions.

According to the present invention, the scope of services that can be available at each shared self service terminal for each participating financial institution is equal, although each participating financial institution may have different type and different number of services. Each shared self service terminal can be prepared and configured to provide the same type of services to each participating financial institution. Each participating financial institution can have equal opportunity to provide its branded services for its customers at each shared self service terminal.

Depending on the deployment and implementation strategies, one or more service functionalities such as cash withdrawal, cash deposit, passbook update and other functions may be assembled in a single terminal, or each service functionality is dedicatedly installed in a separate terminal as a stand alone terminal.

A service protocol or a transaction protocol is a set of rules and requirements including user displays and dialogues for performing a services or a transaction. A service protocol is a detailed definition on how a transaction system is interacting with a user for generating a transaction or a service request and how the system is interacting with a host server for executing the transaction or the services.

A service protocol among different type of services can be different each other, and the service protocol of the same type of services among different financial institutions can also be different each other. Some or all of the participating financial institutions may decide to use common service protocols for particular services.

Financial institutions may include, but not limited to, banking institutions, multi-finance companies, insurance companies and securities companies. Other institutions such as retail companies, telecommunication companies, airlines companies and other companies or other entities that need a large network of outlets or service points can also participate to provide their services.

For simplicity reasons, through out this document, Bank-A, Bank-B and Bank-C are used to represent a plurality of financial institutions. Also, through out this document, the term transaction and services are the same, and can be used interchangeably or both.

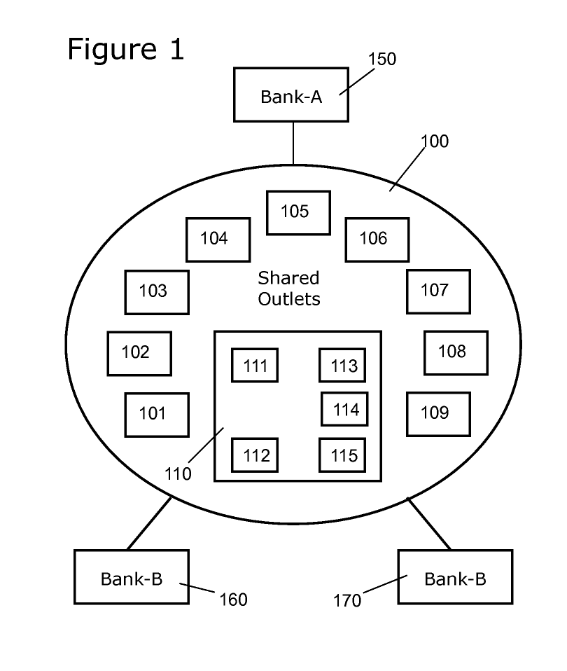

FIG. 1 is a simplified diagram of an exemplary network (100) of shared outlets consisting of shared outlets (101, 102, 103, 104, 105, 106, 107, 108, 109 and 110) representing many shared outlets, in which each shared outlet can accommodate a plurality of shared self service terminals. There are three participating banks, which are Bank-A (150), Bank-B (160) and Bank-C (170) representing many banks and financial institutions.

The number of shared outlets can be as many as needed and the number of participating financial institutions is also not limited to those mentioned in the Figure.

In this exemplary network (100), the shared outlet (110) can accommodate ATM (111), CDM (112), SSPP (113), SSSP (114) and SST (115) representing a plurality of shared self service terminals. The SST (115) can be an information terminal, a payment terminal, a bank item (passbook, card, etc) issuing terminal or any self service terminal. The number of shared self service terminals installed in each shared outlet can be as many as needed and the number of each type of terminal can also be as many as needed.

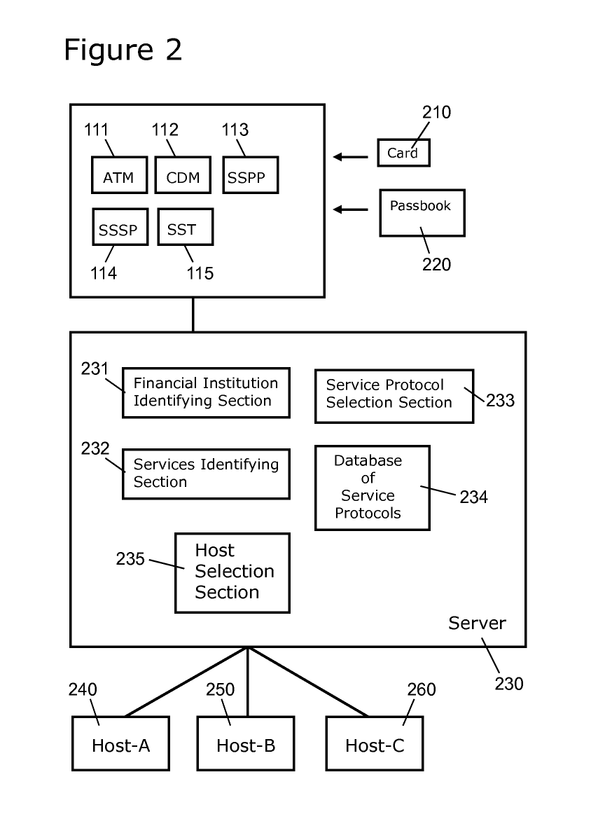

FIG. 2 is a simplified block diagram describing an exemplary embodiment of a system of the present invention.

The server (230) comprises at least one database (234) for storing the service protocols of each type of services of each participating financial institution. Each service protocol can be identified using the financial institution identifier and the service type identifier.

Each service protocol may have at least two sections, which are the portion specifying the interface with the user and the portion specifying the interface with the host computer.

Traditionally, for the type of services such as balance inquiry services, cash withdrawal services, cash deposit services, fund transfer services and payment services, the portion of service protocols for the interaction with the host computer is generally the same for all participating institutions.

However, for the type of services including some non-routine services such as passbook update services, account statement printing services, passbook issuing services, card issuing services, account opening services, account closing services, loan application services, information collection services, information renewal/updating services, information distribution services, personal communication services between a customer and a financial institution and other unique and specific services of particular institutions, the portion of service protocols for the interaction with the host computer is generally different from institution to institution.

The server (230) further comprises a financial institution identifying section (231) for identifying a financial institution associated with a service initiation device presented by a user, which can be a card (210) or a passbook (220) or other initiation devices (not shown in the Figure).

The server (230) further comprises a service identifying section (232) for identifying a services or transaction selected by the user.

The server (230) further comprises a service protocol selection section (233) for selecting and retrieving a service protocol from the database (234) based on the financial institution identified by the financial institution identifying section (231) and the type of the selected services identified by the service identifying section (232).

The server (230) further comprises a host selection section (235) for selecting a host computer associated with a participating financial institution based on the financial institution identified by the financial institution identifying section (231). Additionally, based on the service initiation device (210 or 220) which is associated with an account, the services or transaction is executed according to the selected service protocol. The host selection section (235) can be a switch engine for switching or routing the service requests or the transaction requests to a designated host computer for authorizations.

Host-A (240), Host-B (250) and Host-C (260), in this embodiment, can be associated with participating Bank-A (150), Bank-B (160) and Bank-C (170) of FIG. 1 respectively. If the presented service initiation device (210 or 220) is associated with the Bank-A (150), then Host-A (240) is selected for the execution and authorization of the services. If the presented service initiation device (210 or 220) is associated with the Bank-B (160), then Host-B (250) is selected for the execution and authorization of the services. If the presented service initiation device (210 or 220) is associated with the Bank-C (170), then Host-C (260) is selected for the execution and authorization of the services.

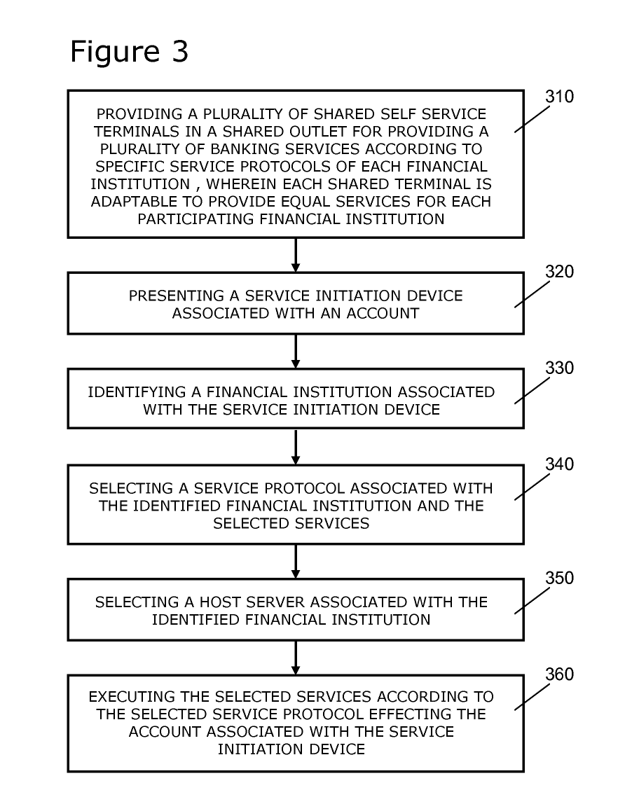

An exemplary embodiment of a preferred method of the invention is now described with reference to FIG. 3 and also FIGS. 1 and 2.

First, step (310), which is the step of storing in a database (234) the service protocol of each type of services or transaction associated with each participating financial institution. Then, a plurality of shared self service terminals (111, 112, 113, 114 and 115) are prepared accordingly and installed in a shared outlet. The preparation may include placing or associating the branding of each participating financial institution with the shared outlet and/or the plurality of shared self service terminals (111, 112, 113, 114 and 115).

For any existing participating institution that needs to add or top-up its new services, the service protocols of the new services can be stored in the database (234), and then the system and other required works are prepared accordingly.

For any existing participating institution that needs to change its existing service protocol of a particular services, the existing service protocol can be modified or replaced with the new service protocol, and then the system and other required works are adjusted accordingly.

For any new additional participant(s), the service protocol of each type of services or transaction associated with each of the new participating institution(s) can be stored in the database (234), and then the system and other required works are prepared accordingly.

A tool or a facility may be provided for each participating institution to create and/or modify its own service protocols and self-upload the service protocols to the system and the system will then automatically adjust or update the changes accordingly.

At step (320), a service initiation device (210 or 220) is presented by a user at one of the the plurality of shared self service terminals (111, 112, 113, 114 and 115) for initiating a service or transaction. The service initiation device can be a card, a passbook or other means. In other embodiment, in the absence of a service initiation device mentioned above, a user biometric means can be used to initiate a services.

At step (330), upon accepting the service initiation device (210 or 220), a financial institution is identified from the information in the presented service initiation device (210 or 220).

Next, upon identifying the financial institution, an application or a file or a portion of a service protocol displaying a menu of services or a list of services associated with or provided by the financial institution is activated and presented to the user for then selecting the desired services or transaction.

In certain implementation, in which certain services are provided at specific terminals separated from other services which are provided at different terminals, the selection of the services is made by the user by firstly selecting the terminal which serves the desired services before presenting the service initiation device (210 or 220).

At step (340), a service protocol is selected and retrieved from the database (234) based on the identified financial institution and the selected type of services.

In certain type of services, additional information including identification information such as biometric information, national identity information or other personal identification information may be required to be provided by the user.

At step (350), a host computer is determined and selected based on the identified financial institution. The service or transaction request is then routed or forwarded to the selected host computer.

At step (360), the requested services or transaction is executed according to the selected service protocol, which effects the account associated with the presented service initiation device (210 or 220).

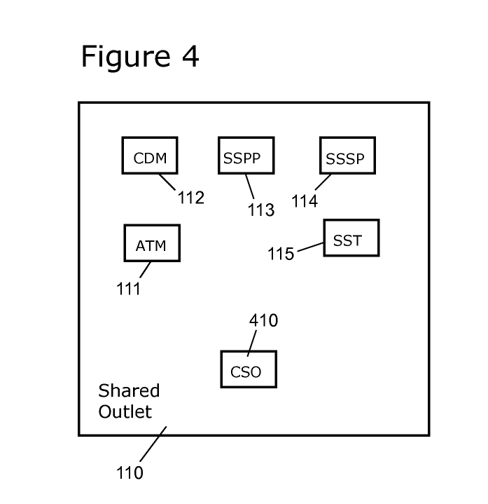

An exemplary embodiment of a shared outlet according to the present invention is now described with reference to FIG. 4.

The shared outlet (110) comprises a plurality of shared self service terminals (111, 112, 113, 114 and 115) for providing a plurality of services for participating financial institutions.

Each shared self service terminal can be prepared to provide equal services for each participating financial institution although each financial institution may have different number and different type of services as well as different business strategy.

The plurality of shared self service terminals (111, 112, 113, 114 and 115) can be prepared and upgraded from time to time to accommodate the business needs of each participating financial institution.

At least one person (410), typically called a customer service officer (CSO), can be placed in the shared outlet (110) to provide services which are not supported or currently not supported or temporarily not being supported by or through the plurality of shared self service terminals (111, 112, 113, 114 and 115).

The number of shared self service terminals in the shared outlet can be increased or decreased from time to time depending on the need.

The number of shared outlets can be as many as needed, and can be increased and decreased including the relocation of at least some of the existing outlets from time to time depending on the need.

The shared outlet can be branded with all participating institutions. Advertisement displays can also be done inside and/or around the outlet.

The shared outlet, in addition to financial institutions, can also be prepared to provide services for other institutions as well as other business entities.

The present invention may be embodied in other forms without departing from its spirit and scope. The embodiments described above are therefore illustrative and not restrictive, since the scope of the invention is determined by the appended claims rather then by the foregoing description, and all changes that fall within the meaning and range of equivalency of the claims are to be embraced within their scope.

1. A system for providing automated banking services associated with a plurality of financial institutions through at least one shared outlet, comprising:
a plurality of shared self service terminals located in the at least one shared outlet for providing a plurality of services including at least cash withdrawal services, cash deposit services, balance inquiry services, fund transfer services, payment services and at least one of the services selected from the group consisting of at least: passbook update services, account statement printing services, passbook issuing services, card issuing services, account opening services, account closing services, loan application services, information collection services, information renewal/updating services, information distribution services and personal communication services between a customer and a financial institution, wherein each shared self service terminal is adapted or adaptable to provide equal services for each participating financial institution;
at least one service initiation device associated with at least one account;
at least one server, operably connected to the plurality of shared self service terminal, comprising:
a financial institution identifying section for identifying a financial institution associated with the presented service initiation device, a plurality of service protocols associated with each type of services associated with each participating financial institution, a service protocol selection section for selecting a service protocol associated with the identified financial institution and the type of services selected by the user and a host selection section for selecting a host server associated with the identified financial institution for then executing the services effecting the account associated with the service initiation device in a manner according to the selected service protocol.

2. The system of claim 1, wherein the service initiation device is a card.

3. The system of claim 1, wherein the service initiation device is a passbook.

4. The system of claim 1, wherein the service protocol further includes requesting the user to provide additional information.

5. The system of claim 4, wherein the additional information includes the user's biometric information.

6. A method for providing automated banking services associated with a plurality of financial institutions through at least one shared outlet, comprising the steps of:
providing a plurality of shared self service terminal in the at least one shared outlet for providing a plurality of services including at least cash withdrawal services, cash deposit services, balance inquiry services, fund transfer services, payment services, passbook update services, account statement printing services and at least one of the services selected from the group consisting of at least: passbook issuing services, card issuing services, account opening services, account closing services, loan application services, information collection services, information renewal/updating services, information distribution services and personal communication services between a customer and a financial institution, wherein each shared self service terminal is adapted or adaptable to provide equal services for each participating financial institution;
presenting a service initiation device associated with an account;
identifying a financial institution associated with the presented service initiation device;
selecting a service protocol associated with the identified financial institution and the selected type of services;
selecting a host server associated with the identified financial institution; and
executing the services according to the selected service protocol effecting the account associated with the service initiation device.

7. The method of claim 6, wherein the step of providing the at least one shared self service terminal includes the step of storing in a database the service protocol associated with each type of services associated with each participating financial institution.

8. The method of claim 6 further includes the step of selecting a services.

9. The method of claim 6, wherein the service initiation device is a card.

10. The method of claim 6, wherein the service initiation device is a passbook.

11. The method of claim 6, wherein the service protocol further includes requesting the user to provide additional information.

12. The method of claim 11, wherein the additional information includes the user's biometric information.

13. The method of claim 6 further includes the step of associating each participating financial institution s branding with the at least one shared outlet.

14. A shared outlet for providing banking services associated with a plurality of participating financial institutions, comprising:
a plurality of shared self service terminal for providing a plurality of services including at least cash withdrawal services, cash deposit services, balance inquiry services, fund transfer services, payment services and at least one of the services selected from the group consisting of at least: passbook update services, account statement printing services, passbook issuing services, card issuing services, account opening services, account closing services, loan application services, information collection services, information renewal/updating services, information distribution services and personal communication services between a customer and a financial institution, wherein each shared self service terminal is prepared or preparable to provide equal services for each participating financial institution in a manner according to specific service 20 protocols associated with each participating financial institution.

15. The shared outlet of claim 14 further comprising at least one person for providing the services which are not supported by or through the at least one shared self service terminal.

16. The shared outlet of claim 14 further providing a branding display for each participating institution.
